(19) United States
(12) Patent Application Publication
(10) Pub. No.: US 2005/0078646 A1
(43) Pub. Date: Apr. 14, 2005

(54) Method and system for effective communication between a child piconet coordinator and a target device

(75) Inventors: Seong-seol Hong, Suwon-si (KR); Moon-young Choi, Seoul (KR); In-hwan Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/944,180

(22) Filed: Sep. 20, 2004

(30) Foreign Application Priority Data
Sep. 28, 2003 (KR) 10-2003-0064857
Oct. 2, 2003 (KR) 10-2003-0068844

(51) Int. Cl. H04Q 7/24

(52) U.S. Cl. 370/338; 370/352; 370/401

(57) ABSTRACT

A method for a first device which is a member of a parent piconet and a child PNC of its child piconet to communicate with a second device existing in either the parent piconet or the child piconet, including the steps of generating a command frame to request a channel time for communication with the second device by use of an identifier to identify the piconet and the device ID uniquely allotted to a device and transmitting the generated command frame to a parent PNC, receiving the channel time allotted from the parent PNC to which the command frame has been transmitted, during which the first device and the second device are allowed for communication, and allowing data to be transmitted and received between the first device and the second device during the allotted channel time. Correct communication can be made between two devices although they have identical device IDs.

### BACKGROUND OF THE INVENTION

This application claims the priority of Korean Patent Application Nos. 10-2003-0064857 and 10-2003-0068844 filed on Sep. 18, 2003, and Oct. 2, 2003, in the Korean Intellectual Property Office, the disclosures of which are incorporated herein by reference.

1. Field of the Invention

Apparatuses and methods consistent with the present invention relate to transmitting and receiving data between devices in a wireless communication environment, and more particularly, to communication between devices operated in a wireless personal area network (PAN) environment and existing in different piconets.

The different piconets may comprise a parent piconet and a child piconet, or a child piconet and a different child piconet, when a parent piconet and one or more child piconets coexist.

2. Description of the Prior Art

A parent piconet and a child piconet can coexist in the wireless PAN. It is advantageous in that the parent piconet and the child piconet can share a frequency when they are in coexistence. However, where the child piconet generates a media access control (MAC) header to transmit a command frame or a data frame to a specific target device, a problem of indefiniteness may be caused by coexistence of the parent piconet and the child piconet.

FIG. 1 is a block diagram illustrating communication by a child piconet according to the IEEE 802.15.3 Standard in a conventional way.

A piconet coordinator (PNC) secures that each of devices associated within the piconet has a device identifier (which is indicated as “DEVID” in the IEEE Standard spec). In this regard, all of the associated devices are actually assigned their unique IDs.

There is an exception to the PNC itself. A device operated as the PNC may have two or more device IDs. Among device IDs which a PNC has, the value of 0x00, called PNCID, is assigned to use a PNC function associated with other devices, and a different device ID value of the PNC is assigned to use communication traffic not relevant to the PNC (that is, not as PNC but for communication as a common device).

When a piconet starts, the PNC assigns itself to an additional device ID to exchange data with other devices which are members of the newly generated piconet.

As illustrated in FIG. 1, a parent piconet and a child piconet operate in an independent manner. The parent piconet and the child piconet assign the devices within their own piconets to unique device IDs. As a result, those devices having the same device IDs can exist both in the parent piconet and the child piconet.

In this situation, where device #4, which is a child PNC and exists in the parent piconet, intends to transmit a command frame to a device #3 13 existing in the parent piconet, the device #4 14 has to generate a MAC header indicating the device #3 13 as a destination device. However, the correct MAC header for transmission of the command frame cannot be generated because the device #4 14 has information on two devices numbered 3, i.e., device # 3 13 and device # 3 23, and the correct MAC header cannot be generated. There is a question of indefiniteness.

Referring to FIG. 2, a single parent piconet 100 can have a plurality of child piconets 110 and 120 below it. When a device #4 114 being a member of a first child piconet 110 and having 4 as DEVID intends to communicate with a device #2 122 being a member of a second child piconet 120 and having 2 as DEVID, there is no method of distinguishing devices 102 and 112 having DEVID as 2 existing in the piconets 100 and 110.

In the wireless PAN, an independent piconet such as a parent piconet and a dependent piconet such as a child piconet can coexist. However, there has been no method for communication between a member of the independent piconet and a member of the dependent piconet, or between a member of the dependent piconet and a member of a different dependent piconet.

### SUMMARY OF THE INVENTION

Accordingly, the present invention is conceived to solve the problem. An aspect of the present invention is to provide a method for effective communication between a device being a device of a parent piconet and simultaneously functions as a child piconet and a specific destination device targeted for communication.

Another aspect of the present invention is to provide a method for enabling a device belonging to a piconet to communicate with a device existing in a different piconet. Especially, there is provided a method for solving such a problem of communication at a MAC level, without using a bridging concept in the specifications of the IEEE 802.1 Standard.

It is an aspect of the present invention to provide a method for allowing a device which is a device of a parent piconet and functions as a child PNC to communicate with a device of a specific target device.

In order to accomplish this and the other aspects of the present invention, there is provided a method for a first device which is a member of a parent piconet and a child PNC of its child piconet to communicate with a second device existing in either the parent piconet or the child piconet, comprising the steps of generating a command frame to request a channel time for communication with the second device by use of an identifier to identify the piconet and the device ID uniquely allotted to a device and transmitting the generated command frame to a parent PNC (1st step), receiving the channel time allotted from the parent PNC to which the command frame has been transmitted, during which the first device and the second device are allowed for communication (2nd step), and allowing data to be transmitted and received between the first device and the second device during the allotted channel time (3rd step).

According to another aspect of the present invention, there is provided a system for a first device which is a member of a parent piconet and a child PNC of its child piconet to communicate with a second device existing in either the parent piconet or the child piconet, comprising the first device generating a command frame to request a channel time for communication with the second device by use of an identifier to identify the piconet and the device ID uniquely allotted to a device and transmitting the generated command frame to a parent PNC, and being allotted the channel time for communication with the second device from the parent PNC, and the second device being allotted a device ID from the child PNC or the parent PNC and receiving data from and transmitting data to the first device during the channel time.

According to another aspect of the present invention, there is provided a method for communicating a first device with a second device coexisting in a piconet system under which a parent piconet and one or more child piconet are in coexistence, comprising the steps of a first child PNC receiving information on member device (a) on the PNCs from the parent PNC and other child PNCs through a predetermined command frame and storing them in its own device information table (1^{st} step), a member device (b), of the child piconet for which the first child PNC is responsible, receiving information on the member device (a) from the first child PNC through a predetermined command frame and storing the received information in its own device information table (2^{nd} step), a first device belonging to the member device (a) attempting to communicate with a second device belonging to a member device of a different piconet (3^{rd} step), the first device generating a data frame to be transmitted to the second device by use of the device information table storing in itself (4^{th} step), the first device transmitting the generated data frame to the second device (5^{th} step), wherein the device information table comprises an identifier to identify the piconet.

### BRIEF DESCRIPTION OF THE DRAWINGS

The above and other aspects, features and advantages of the present invention will become apparent from the following description of exemplary embodiment given in conjunction with the accompanying drawings, in which:

FIG. 1 is a block diagram illustrating communication by a child piconet according to the IEEE 802.15.3 Standard in a conventional way;

FIG. 2 is a view illustrating a piconet system having a plurality of piconets;

FIG. 3 is a view illustrating a hierarchical structure of each device according to the IEEE 802.15.3 Standard;

FIGS. 4A-1 and 4A-2 are views each illustrating Internal DEV Association Table which a child PNC has according to a conventional art;

FIGS. 4B-1 and 4B-2 are views each illustrating an example of application of a PNID to the Internal DEV Association Table which a PNC has according to an embodiment of the present invention;

FIG. 4C is a view illustrating another example of application of a PNID to the Internal DEV Association Table which a PNC has according to another embodiment of the present invention;

FIG. 5A is a view illustrating a configuration of a PNC information command frame;

FIG. 5B is a view illustrating a detailed configuration of a DEV info field of the PNC information command frame;

FIG. 5C is a view illustrating a configuration of a header part of a MAC frame;

FIG. 6 is a view illustrating when the PNID is applied in the situation of FIG. 1;

FIG. 7 is a view illustrating a process of transmission and reception of a command frame between a device and a PNC by application of the PNID;

FIG. 8 is a flow chart showing a process of the present invention;

FIGS. 9A-1-9A-3 are views illustrating a first example of Internal DEV Association Tables which the devices respectively have;

FIG. 9B is a view illustrating a second example of Internal DEV Association Tables which the devices respectively have;

FIG. 10 is a flow chart illustrating an operation of the present invention; and

FIG. 11 is a flow chart illustrating an operation of the present invention subsequent to the operation in FIG. 10.

### DETAILED DESCRIPTION OF THE INVENTION

Hereinafter, exemplary embodiments of the present invention will be described in detail with reference to accompanying drawings.

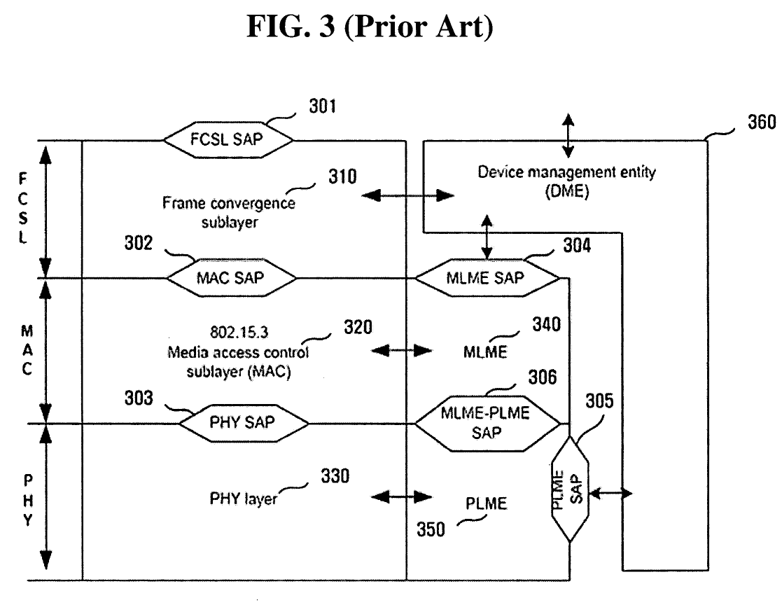

Referring to a stack structure shown in FIG. 3, a scheme for having communication between devices according to the IEEE 802.15.3 Standard will be described in a brief manner. An MAC layer 320 and a Physical (PHY) layer have their respective management entities. The management entity that the MAC layer has is called MLME (MAC layer management entity) 340 and the management entity that the PHY layer has is called PLME (PHY layer management entity) 350. These entities provide service interfaces so as to allow layer management functions to be performed in each layer.

Also, to perform a correct operation in a MAC layer, a device management entity (DME) 360 must exist. The DME operates independently in each layer, having functions to collect information on layer-dependent status of each layer from management entities in several layers and set layer-specific parameters of each layer.

Several service access points (SAP) serve as gates to transmit information among the variety of entities described above. Information between the PHY layer 330 and the MAC layer 320 is transmitted by a PHY SAP 303 and information between the MAC layer 320 and a frame convergence sub layer (FCSL) 310 is transmitted by a MAC SAP 302. Information between DME 360 and PLME 350 is transmitted by a PLME SAP 305 and information between MLME 340 and PLME 350 is transmitted by a MLME-PLME SAP 306.

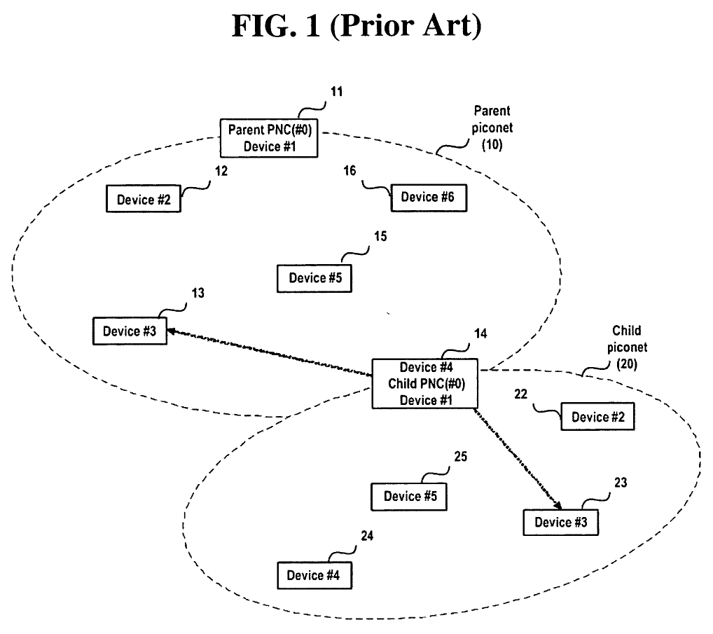

FIGS. 4A-1 and 4A-2 are views each illustrating an Internal DEV Association Table which a child PNC has according to a conventional art. Each device uses an Internal DEV Association Table to store various information on members in the same piconet the device itself is in. A device which is a device of a parent piconet and functions as a child PNC of a child piconet has both Internal DEV Association Tables 410 and 420: one for storing information on members existing in the parent piconet and the other for storing information on members existing in the child piconet. A field relevant to parent piconet information, a field relevant to device association (DEV association) information, and a field relevant to vender specific information or other fields are arrayed by device ID in each table. Fields may have sub-fields having detailed information of the fields.

Each device has information on the fields as described above in a row. The tables 410 and 420 show that there can exist devices having the same device IDs. Thus, it is not possible for a device to transmit data to another device having the identical device ID.

FIGS. 4B-1 and 4B-2 are views each illustrating an example of application of PNID to the Internal DEV Association Table which a PNC has according to the present invention. PNID (piconet identifier) and BSID (beacon source identifier) defined in the IEEE 802.15.3 Standard specification are similar to each other in that both of them are assigned to each piconet. If a PNC discovers a different PNC using the identical PNID or BSID, it changes its PNID or BSID. In this case, PNID must be changed, but BSID must not be changed. The Standard specification provides that both of PNID and BSID cannot be changed simultaneously. Thus, it would be more efficient and reliable to use PNID as an identifier to identify the piconet. According to the present invention, a PNID is added to each of the Internal DEV Association Tables, added PNIDs are transmitted whenever exchanging a variety of primitives, so that an unique ID of each device can be identified even though the device IDs (DEVIDs) are identical, and the devices can communicate with the other device as desired. For example, if a child PNC desires to transmit data to a device #2 12, a member of its parent piconet, it can transmit the data correctly to the device #2 12 since the device whose device ID is 2 and PNID is 0x06 is unique, even though there exist two devices 12 and 22 whose device IDs are 2.

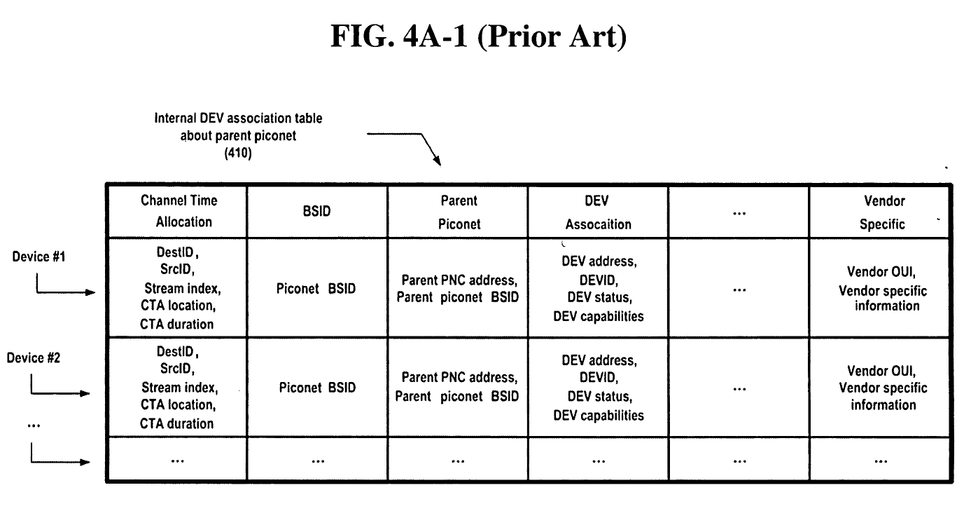

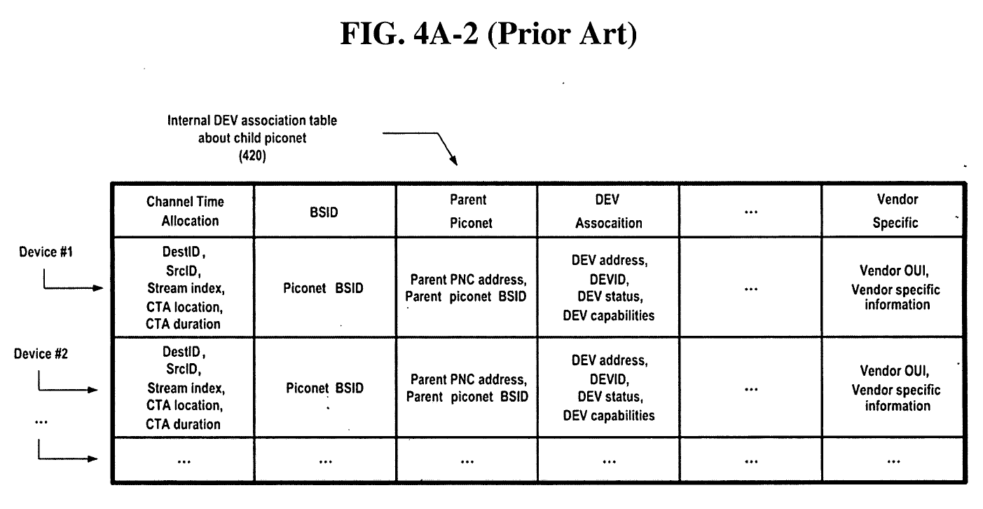

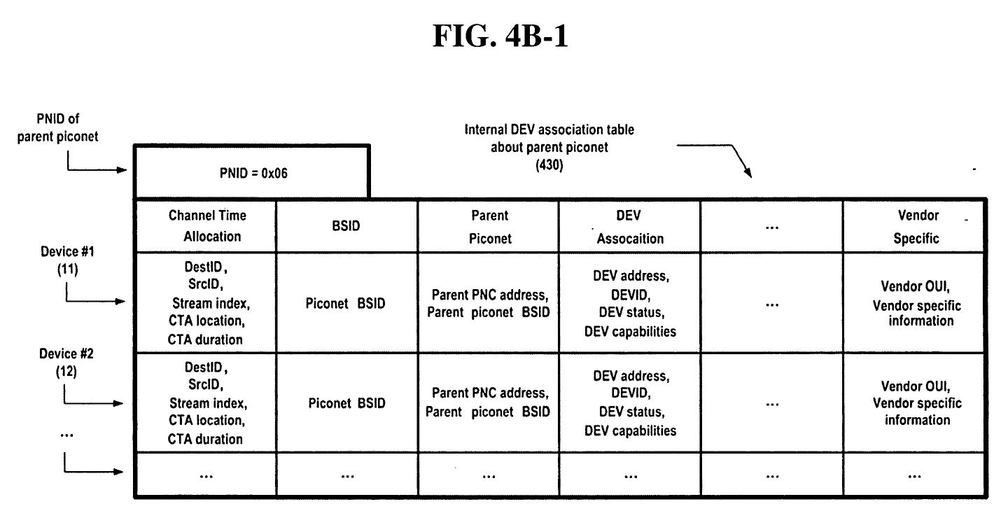

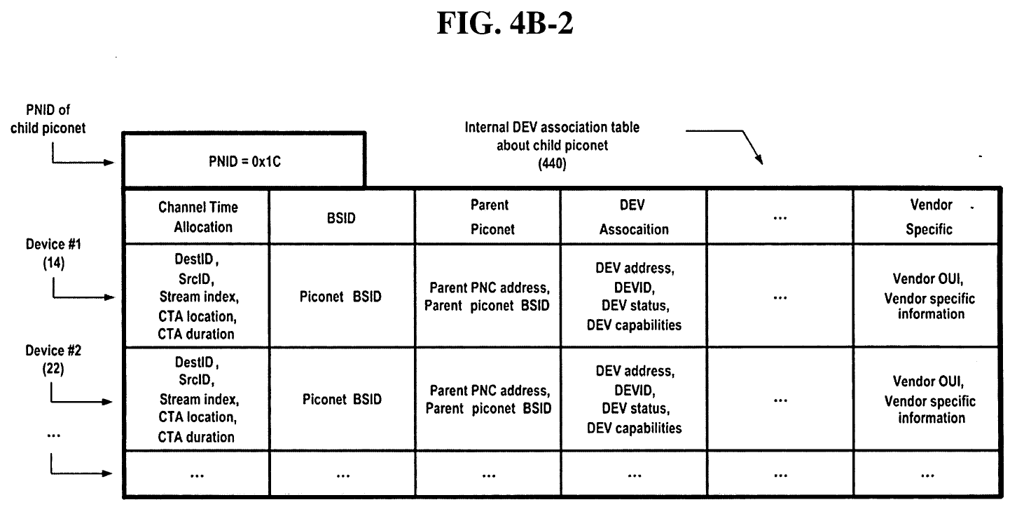

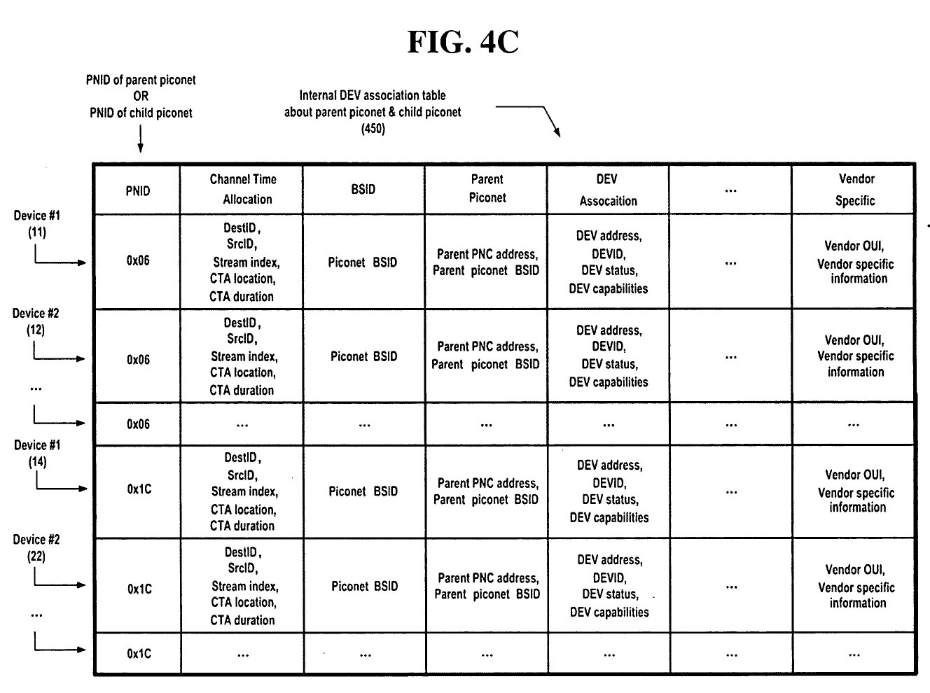

In addition to the method of applying a PNID to the table itself, a method of entering PNIDs into each row corresponding to each device while using a single table may be considered as another embodiment of the present invention. FIG. 4C is a view illustrating another example of application of a PNID to the Internal DEV Association Table which a PNC has according to another embodiment of the present invention. This method may be disadvantageous in that a PNID must be entered into each row. However, this method makes it advantageous to manage a single table in a simple manner, having no need to have a plurality of tables by piconet. In the single Internal DEV Association Table according to this method, a PNID is added to each row of Internal DEV Association Table, added PNIDs are transmitted whenever exchanging a variety of primitives, so that an unique ID of each device can be identified even though the device IDs (DEVIDs) are identical, and the devices can communicate with the other device as desired.

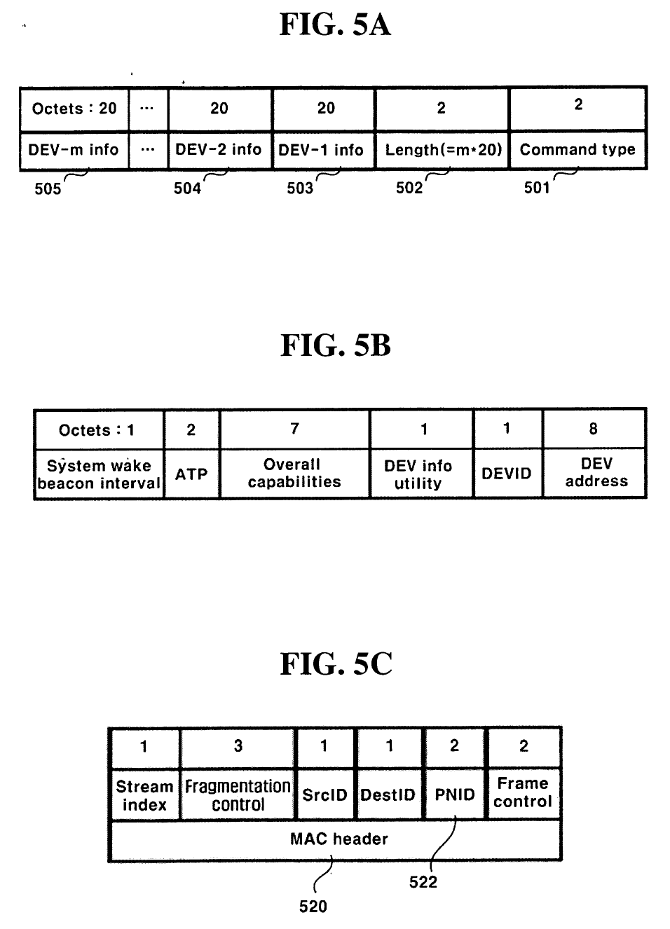

FIG. 5A is a view illustrating a configuration of a PNC information command frame, FIG. 5B is a view illustrating a detailed configuration of a DEV info field of the PNC information command frame, and FIG. 5C is a view illustrating a configuration of a header part of a MAC frame;

Member devices of a parent piconet periodically receive information on members existing in the parent piconet from a parent PNC through a PNC information command frame. A child PNC belonging to members of the parent piconet has already known information on members of a child piconet covered by itself, and thus, the child PNC can construct an Internal DEV Association Table by use of information already known on the child piconet members and information contained in the transmitted frame. The PNC information command frame comprises a Command Type filed 501 to indicate types of command frames, a Length field 502 to indicate the amount of information to be occupied by a DEV info field, and a plurality of DEV info fields 503 to 505. Each of the DEV info Fields has detailed constructions as illustrated in FIG. 5B.

The PNC information command is a command frame being broadcasted if a change has occurred within a piconet. Thus, the child PNC broadcasts the change in a child piconet through the PNC information command frame, and the parent PNC and other child PNCs having received the command frame broadcast the PNC information command as a change has occurred in their own piconets. Since DEV info fields 503 through 505 are variable, they are not limited in the number of devices.

However, since the Internal DEV Association Table is classified by PNID, information on PNID is indispensable. The PNID information is written in a PNID field, one field constituting the MAC headers 520. The construction of MAC 520 is shown in FIG. 5C.

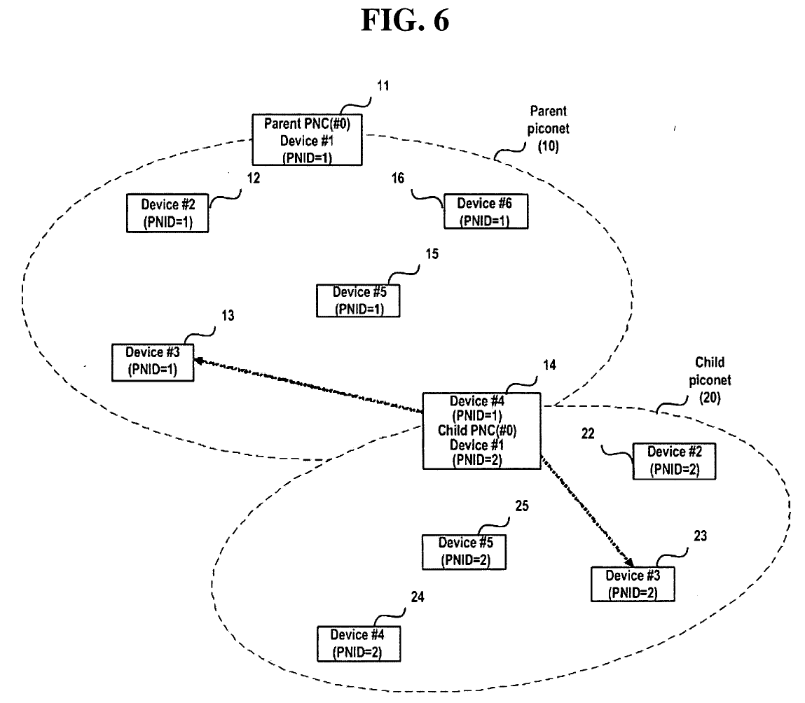

FIG. 6 is a view illustrating a difference created when PNID is applied in the situation of FIG. 1. Same as in FIG. 1, if a child PNC 14 desires to transmit data to a device #3 13 of its parent piconet, it can confirm from its own Internal DEV Association Table that the device #3 13 has a device ID of 3 and a PNID of 1. Thus, since the device #3 13 is not identical to the device #3 23 of the child piconet having the identical device ID, data can be correctly transmitted.

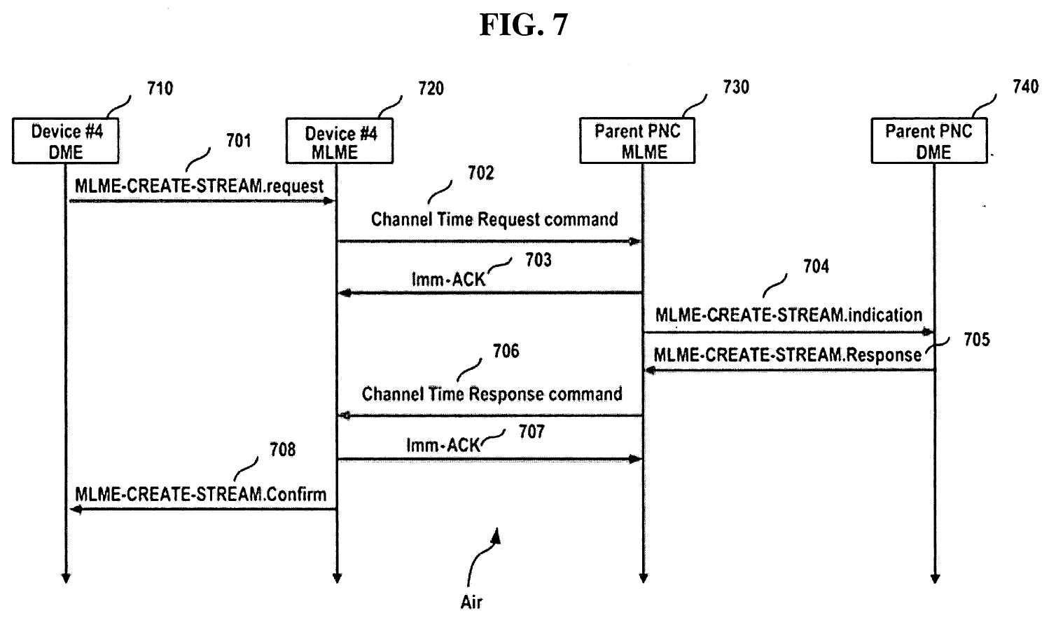

FIG. 7 is a view illustrating a process of transmission and reception of a command frame between a device and a PNC by application of the PNID. Referring to this figure, a primitive CREATE-STREAM among primitives will be described by way of example. The primitive CREATE-STREAM is used when a device requests a PNC a channel time. Initially, a DME 710 on the side of the device generates MLME-CREATE-STREAM.request 701 and then transmits it to MLME 720.

A device #4 14 functions as a device of a parent piconet and simultaneously as a child PNC of its child piconet is allotted the device ID of 4 from a parent PNC. The device #4 14 uses MLME-CREATE-STREAM.request, a primitive corrected to communicate with a specific target device. The device #4 14 has two Internal DEV Association Tables, which are classified by PNID. Thus, if a PNID is added as a new parameter to a primitive described in reference to the conventional art, the table will be structured as follows.

MLME-CREATE-STREAM.request {

PNID,
TrgtID,
DSPSSetIndex,
StreamRequestID,
StreamIndex,
...
DesiredNumTUs,
RequestTimeout
}

An MLME 720 of the device #4 generates a command frame 702 to request a channel time to transmit it to an MLME 730 of a parent PNC. At this time, since the PNID is contained in MLME-CREATE-STREAM.request 701 received from a DME 710 of the device #4 14, a command frame having a correct MAC header can be generated.

The command frame 702 is incorporated into a radio frequency (RF) signal and then transmitted to the parent PNC through the air through a PHY layer. The RF signal is demodulated in the PHY layer on the parent PNC side and the command frame 702 is extracted. The command frame 702 is transmitted to the MLME 730 of the parent PNC after passing through an MAC layer of the parent PNC side. The MLME 730 having received the transmitted command frame 702 generates an Imm-ACK frame 703, a frame for acknowledging receipt of the frame 702, and transmits it to the device #4.

The command frame transmitted to the MLME 730 of the PNC is transmitted to the DME 740 of the PNC in the form of MLME-CREATE-STREAM.indication 704. In response, the DME 740 of the PNC transmits MLME-CREATE-STREAM.response 705 to the MLME 730 of the PNC, and the MLME 730 of the PNC then transmits an RF signal through the air through an MAC layer and a PHY layer. The RF signal includes information on the command frame 706 for CREATE-STREAM response. The RF signal is demodulated in the PHY layer on the device side and the command frame 706 is extracted. The command frame 706 is transmitted to the MLME 720 of the device after passing through the MAC layer of the device side. The MLME 720 of the device receiving the command frame 706 generates an Imm-ACK frame 707 to acknowledge receipt of the frame 706 and transmits it to the PNC side. The command frame transmitted to the MLME 720 of the device is transmitted to the DME 710 of the device in the form of MLME-CREATE-STREAM.confirm 708.

If it is confirmed from a parent PNC 11 that the device #4 14 can communicate with a specific target device, the PNC 11 allots a channel time, as the time available for communication between the device #4 and the target device, through a superframe of a beacon. Then, the device #4 14 can communicate with the target device during the allotted channel time.

It has been described by way of example when a primitive is CREATE-STREAM. However, other primitives such as MLME-DISASSOCIATE, MLME-MEMBERSHIP-UPDATE, MLME-PNC-HANDOVER, MLME-PNC-INFO, MLME-PROBE can also be operated, including the PNID as an added parameter.

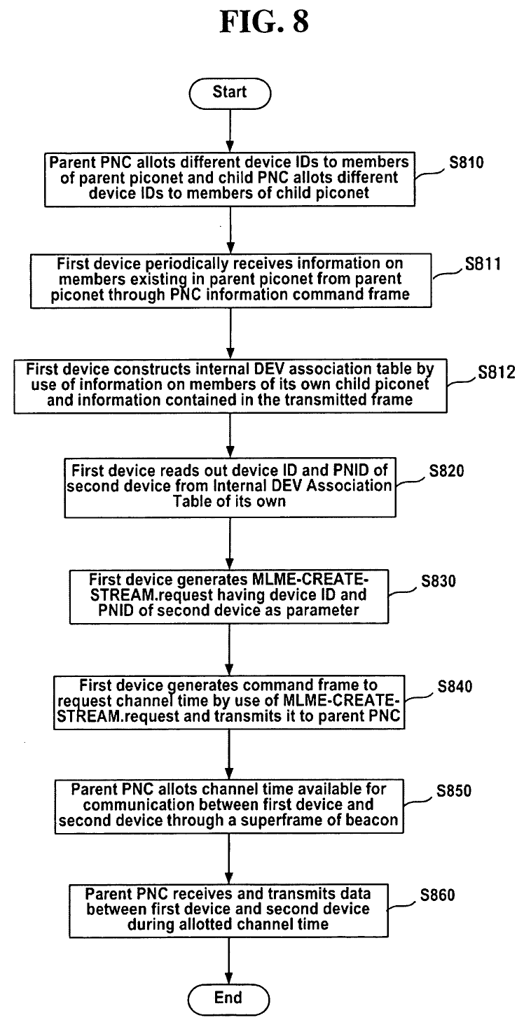

FIG. 8 is a flow chart showing a process of the present invention.

As depicted therein, a parent PNC allots different device IDs to members of the parent piconet, and its child PNC (the first device) allots different device IDs to members of the child piconet (S810). At this time, a first device which is a member of a parent piconet and functions as a child PNC is also allotted a device ID from the parent PNC. In this process, an identical device ID may be allotted both to a device as a member of the parent piconet and a member of the child piconet.

Member devices of a parent piconet periodically receive information on members existing in the parent piconet from a parent PNC through a PNC information command frame. Since the first device is one of the members, it likewise receives the frame transmitted (S811). The first device has already known information on members of a child piconet covered by itself, and thus, it constructs an Internal DEV Association Table by use of information on the child piconet members and information contained in the transmitted frame (S812).

Next, the first device reads out information on the device ID and PNID of a second device from the Internal DEV Association Table of its own (S820). The Internal DEV Association Table may be structured by adding respective PNIDs to the two tables as shown in FIGS. 4B-1 and 4B-2, or by entering a PNID into each row of each table as shown in FIG. 4C.

The first device then generates MLME-CREATE-STREAM.request containing as a parameter information on the device ID and PNID of a target device (second device) (S830). The first device generates a command frame to request a channel time for communication with the target device by use of information on the device ID and PNID of the target device (second device), which the MLME-CREATE-STREAM.request has, and transmits it to the parent PNC (S840). Then, the parent PNC allots the channel time through a superframe of a beacon, during which the first device and the second device can communicate with each other (S850). Then, data is transmitted and received between the first device and the second device during the allotted channel time (S860).

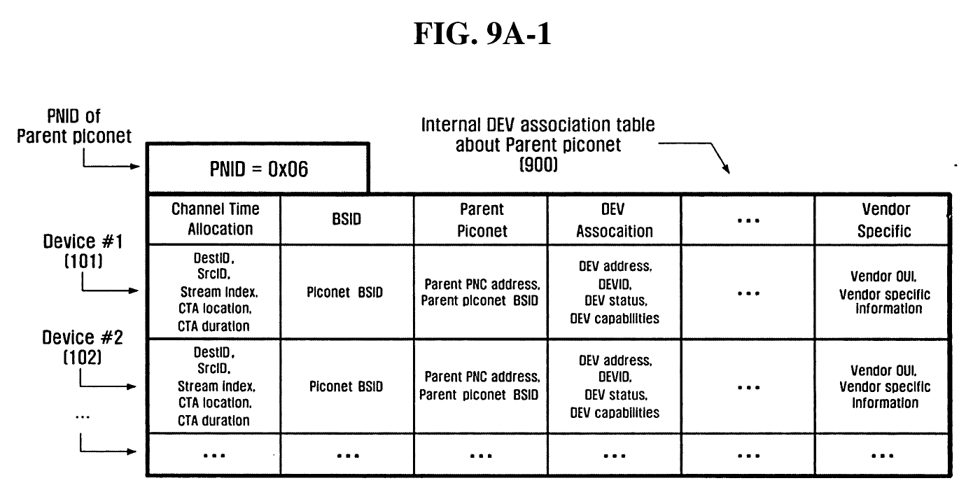

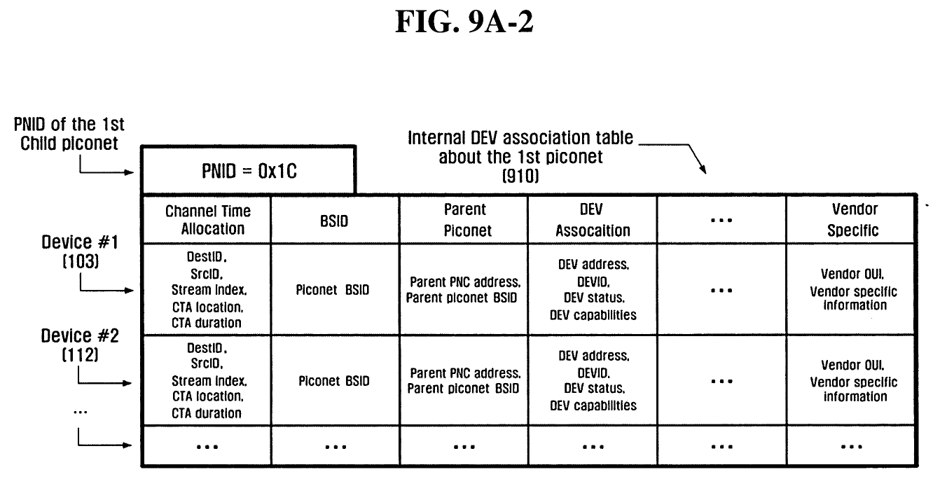

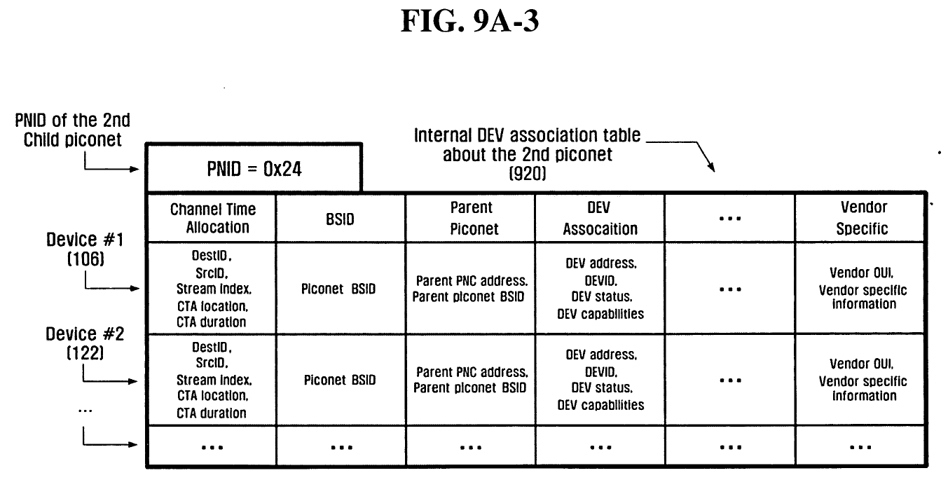

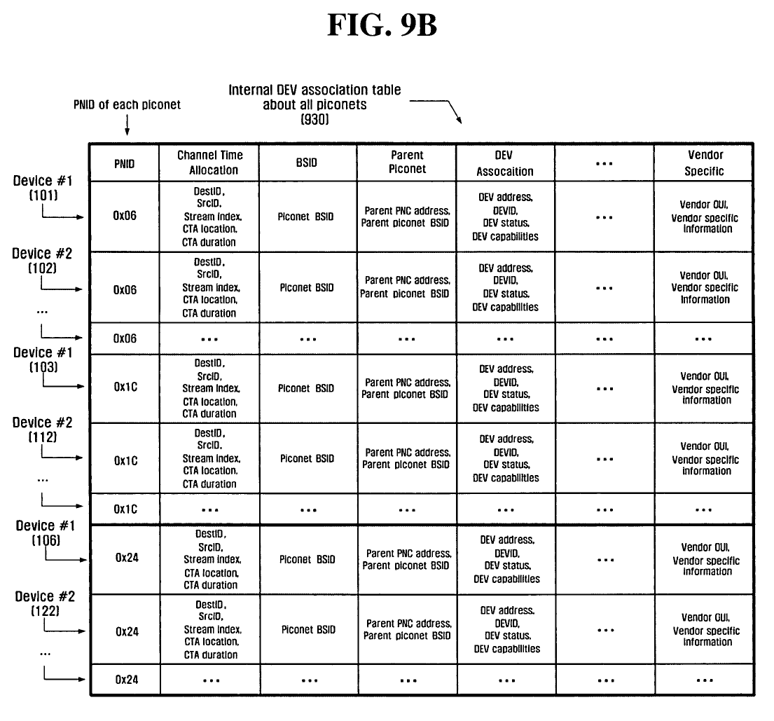

FIG. 9A is a view illustrating a first example of Internal DEV Association Tables which the devices respectively have. In a conventional way, when a new device participates in the piconet, the new device transmits its own device information to the PNC and is associated as a member with the piconet. Through these processes, the PNC obtains information on the piconet members covered by itself and stores the information in the Internal DEV Association Table. The Internal DEV Association Table is a kind of device information table containing therein information on devices within a single piconet, which is used when a device intends to transmit data to a different device.

The PNC periodically transmits plural pieces of device information to each member through a beacon. Then, each member device having received the information stores the information in its own Internal DEV Association Table and can later communicate with a different member device by use of the information contained in the table. In the conventional art, communication is allowable between members within the same piconet; however, there is no method for enabling communication between members within different piconets.

To solve this problem, the PNCs in charge of their own piconets share Internal DEV Association Tables, which they respectively have, through periodic communication between themselves, thereby allowing each PNC to know information on all the devices existing in all the piconets. If the PNC transmits the device information to each member, each member device having received the information stores the received information in its own Internal DEV Association Table, and later transmit data to a destination device by use of the stored information when it intends to communicate with a device belonging to a different piconet. In this case, the PNC passes through a PNC of the piconet to which the destination device belongs, as an intermediate position.

However, although a transmitting device has known device information on a destination device, communication in the piconet is made by DEVID. Here, each device has its own unique DEVID within a single piconet, but duplicate DEVIDs may coexist in other piconets. Thus, there still exists a problem in that a unique destination device cannot be determined.

The present invention enables data to be transmitted to a correct destination device by use of an identifier identifying each piconet, even where there exist duplicate DEVIDs. It is similar to the IEEE 802.1 Standard in a sense that both PNID (piconet Identifier) and BSID (Beacon Source Identifier) are assigned to all the piconets as defined in the Standard specification. If a PNC discovers a different PNC using the identical PNID or BSID to its own, it changes its own PNID or BSID. In this case, the PNID must be changed, and the BSID can be optionally changed. The Standard specification does not allow both PNID and BSID to be changed simultaneously. Taking this into consideration, it is a more efficient method to use PNID as an identifier to identify the piconet. In this regard, PNID is added to each of the Internal DEV Association Tables according to the present invention, and the tables to which the PNID is added are transmitted upon exchanging a variety of parameters, thereby enabling the transmitting device to communicate with the destination device by identifying each device in a unique manner even though there is duplication in device IDs (DEVIDs).

Under the wireless communication environment as shown in FIG. 1, three devices existing in three piconets have respectively one Internal DEV Association Table as shown therein: that is, there are three Internal DEV Association Tables. Each table comprises fields of Channel Time Allocation information, BSID, Parent Piconet and Vendor Specific Information and the like by device. There may exist sub-fields containing detailed information of their upper fields if the fields are needed.

To store information on members existing in the same piconet and on members existing in different piconets, each device uses three Internal DEV Association Tables 900, 910 and 920 containing the information on all of the members existing in the three piconets 100, 110 and 120. Thus, the Internal DEV Association Tables exist in as many numbers as the number of existing piconets, and they are classified based on PNID.

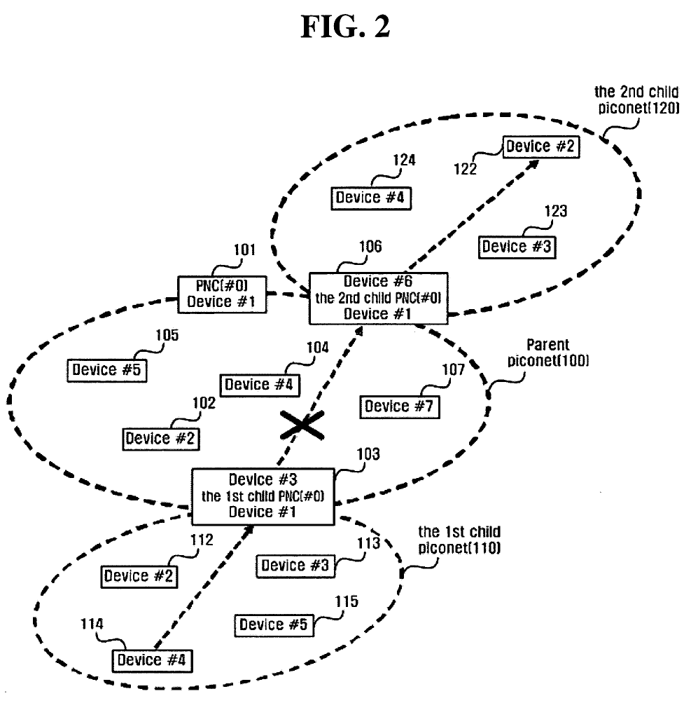

As described in reference to FIG. 2, in a case when device #4 114 of a first child piconet intends to transmit data to device #2 122 of a second child, piconet will be considered. First, if a source device and a destination device have the same PNID, it indicates that they exist in the same piconet, and thus, data can be transmitted directly by use of DEVID of the destination device. Second, if they have different PNIDs, it indicates that they exist in different piconets, and thus, data is initially transmitted to the PNC responsible for the piconet to which the source device belongs, the data is then transmitted to the PNC of the piconet corresponding to the different PNID, and the data is finally transmitted to the destination device. Last, if the destination device belongs to the parent piconet, it indicates that the PNC responsible for the source device and the designation device both belong to the members of the parent piconet, and thus, data can directly be transmitted between both of them.

The example illustrated in FIG. 2 corresponds to the second case described above. That is, when device #4 114, a member of the first child piconet 110 intends to transmit data to device #2 122, a member of the second child piconet 120, the device #4 114 first transmits the data to the first child PNC 103 responsible for the piconet to which it belongs. Then, the first child PNC 103, a member of the parent piconet, transmits the data to the second child PNC 106, which is also a member of the parent piconet, and the second child PNC 106 transmits the data to device #2 122, a member of its own piconet.

In addition to a method of adding PNID to the table itself as described above, another method of applying PNID to each row corresponding to each device while using a single table may be considered as another embodiment of the present invention. FIG. 9B illustrates an example of applying PNID to Internal DEV Association Table that each device has in this case. If the table is constructed in this manner, PNID must be entered into each column. However, using this method, there is no need to have a plurality of tables by piconet, and thus, PNID can be simply managed with a single table 930. In the single Internal DEV Association Table according to this method, a PNID is added to each of the rows and added PNIDs are transmitted whenever exchanging a variety of primitives, so that an unique ID of each device can be identified even though the device IDs (DEVIDs) are identical, and the devices can communicate with the other devices as desired.

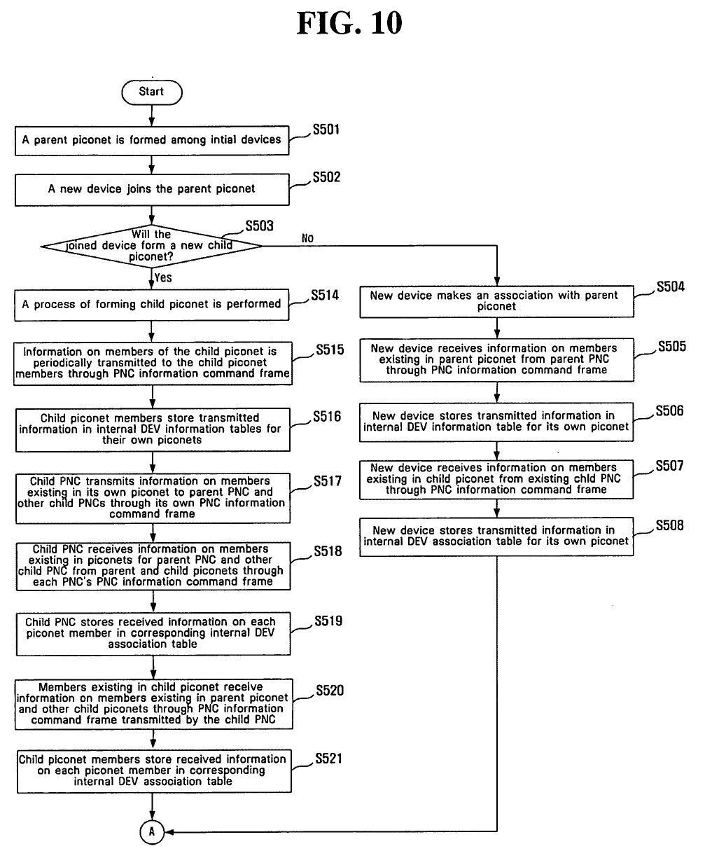

FIG. 10 is a flow chart illustrating an overall operation of the present invention.

An initial piconet between initial devices, a parent piconet is constructed (S501). If a new device joins the network formed by the parent piconet (S502), the new device determines whether to be associated with the parent piconet or to construct a child piconet (S503).

If the device determines to be simply associated with the parent piconet, it passes through the association process as defined in the Standard specification (S504). Next, the device periodically receives information on members existing in the parent piconet from the parent PNC through the PNC information command frame (S505), and stores the transmitted information in the Internal DEV Association Table for its own piconet (S506).

Where child piconets have already formed, the device periodically receives information on members existing in the child piconets from the child PNCs through the PNC information command frame (S507). That is, the child PNC transmits information on the members existing in its own piconet to the parent PNC and other child PNCs through the PNC information command frame, and the parent PNC and other child PNCs transmit the transmitted information to the members existing in their own piconets. Thereafter, each device stores the transmitted information in the ‘International DEV Association Table’ for each piconet (S508).

In step (S503), where the device having joined the network determines to form a child piconet, that is, where it determines to be a child PNC, it passes through the child piconet-forming process (S514), which proceeds according to the conventional Standard specification.

All the devices existing in a child piconet periodically receives information on the members existing in the child piconet from the child PNC through the PNC information command frame (S515), and stores the transmitted information in the Internal DEV Association Tables for their own piconets (S516). Thereafter, the child PNC transmits the information on the members existing in its own piconet to the parent PNC and the other child PNCs through its own PNC information command frame (S517). The parent PNC and each of the child PNCs stores the transmitted information in the Internal DEV Association Table for the concerned piconet.

The child PNC receives information on the members existing in the parent PNC and other child PNCs from them through the PNC information command frame of each PNC (S518). The child PNC having received the information stores the received information on each of the piconet members in the corresponding Internal DEV Association Tables (S519). Members existing in the child piconet receives information on the members existing in the parent piconet and the other child piconets through the PNC information command frame (S520). The devices having received the transmitted information store the received information in the corresponding Internal DEV Association Tables (S521).

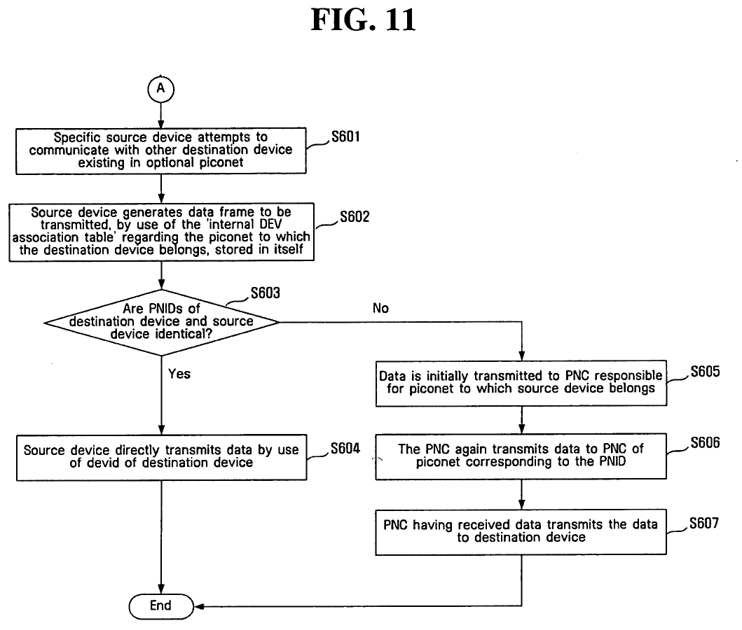

Same as in the process shown in FIG. 10, all of the devices obtain information on all the devices existing in all of the piconets and store them in their own Internal Dev Association Table, and thereafter, they can transmit and receive data among the devices through the process shown in FIG. 11.

First, a specific source device attempts to communicate with another destination device existing in an optional piconet (S601). Then, the source device generates a data frame to be transmitted, by use of the Internal DEV Association Table of the piconet to which the destination device belongs, stored in itself (S602).

Then, the source device determines whether the PNID of the destination device is identical to its own PNID (S603). If the PNIDs of the source device and the destination device are identical, it indicates that they coexist in the same piconet, and thus, it directly transmits the data by use of the DEVID of the destination device (S604).

However, if their PNIDs are different, it indicates that they exist in different piconets. Thus, the source device initially sends the data to the PNC responsible for the piconet to which the source device belong (S605), and the PNC again transmits the data to the PNC of the piconet corresponding to the different PNID (S606). Thereafter, the data is transmitted to the destination device (S607). If the PNID of the destination device refers to the PNID of the parent piconet, it indicates that the PNC responsible for the source device and the designation device are both the members of the parent piconet, and thus, data can be transmitted between both of them.

As described above, where a device belonging to a parent piconet and simultaneously functioning as a child PNC of its child piconet intends to communicate with another device existing in either the parent piconet or the child piconet, correct communication can be made between the two devices although they have identical device IDs.

According to the present invention, communication among devices belonging to different piconets can be made in an efficient and simple manner by use of PNIDs existing in the MAC header, with no inconvenience to use a separate bridging in the upper layer of the MAC layer.

Although the present invention has been described in connection with the exemplary embodiments thereof, it is not limited to the exemplary embodiments thereof. Therefore, it is apparent to those skilled in the art that various changes and modifications can be made thereto without departing from the scope and spirit of the present invention defined by the appended claims.

1. A method for a first device which is a member of a parent piconet and a child piconet coordinator (PNC) of a child piconet to communicate with a second device existing in either the parent piconet or the child piconet, comprising:
generating a command frame to request a channel time for communication with the second device by use of a parent identifier to identify the parent piconet and a child identifier to identify the child piconet and a first device ID and second device ID allotted to the first and second devices, respectively;
transmitting the generated command frame to a parent PNC;
receiving a channel time allotted from the parent PNC to which the command frame has been transmitted, during which the first device and the second device communicate; and
transmitting and receiving data between the first device and the second device during the allotted channel time.

2. The method as claimed in claim 1, wherein the parent and child identifiers to identify the parent and child piconets are piconet identifiers (PNIDs) as stipulated in IEEE 803.15.3 Standard.

3. The method as claimed in claim 2, wherein the operation of generating a command frame comprises:
a) allotting, by the parent PNC, parent device IDs to members of the parent piconet and allotting, by the child PNC, child device IDs to members of the child piconet;
b) reading out, by the parent PNC, the second device ID and a PNID of the second device from an Internal DEV Association Table of the first device, allotted in (a);
c) generating, by the parent PNC, MLME-CREATE-STREAM.request containing as a parameter the second device ID and the PNID of the second device; and
d) generating, by the first device, the command frame to request the channel time for communication with the second device, by use of the second device ID and the PNID of the second device and transmitting the command frame to the parent PNC.

4. The method as claimed in claim 3, wherein the Internal DEV Association Table comprising a plurality of tables, is configured by allotting a unique PNID for each of the plurality of tables of the Internal DEV Association Table of the first device.

5. The method as claimed in claim 3, wherein the Internal DEV Association Table is configured by entering a unique PNID into each row of the Internal DEV Association Table of the first device.

6. A system for a first device which is a member of a parent piconet and a child piconet coordinator (PNC) of a child piconet to communicate with a second device existing in either the parent piconet or the child piconet, comprising:
a first device generating a command frame to request a channel time for communication with the second device by use of a parent identifier and a child identifier to identify the parent piconet and the child piconets, respectively, and first device ID and second device ID allotted to the first and second devices, respectively, and transmitting the generated command frame to a parent PNC, and being allotted the channel time for communication with the second device from the parent PNC, wherein
the second device being allotted the second device ID from the child PNC or the parent PNC and receiving data from and transmitting data to the first device during the channel time.

7. The system as claimed in claim 6, wherein the first and second identifiers to identify the parent and the child piconets are piconet identifiers (PNIDs) as stipulated in IEEE 803.15.3 Standard.

8. The system as claimed in claim 7, wherein a process of generating a command frame and transmitting it to the parent PNC comprises:
a) the parent PNC allotting parent device IDs to members of the parent piconet and the child PNC's allotting child device IDs to members of the child piconet;
b) the parent PNC reading out the second device ID and a PNID of the second device from an Internal DEV Association Table of the first device, allotted in (a);
c) the parent PNC generating MLME-CREATE-STREAM.request containing as a parameter the second device ID and the PNID of the second device; and
d) the first device generating the command frame to request the channel time for communication with the second device, by use of the second device ID and the PNID of the second device and transmitting the command frame to the parent PNC.

9. The system as claimed in claim 8, wherein the Internal DEV Association Table comprising a plurality of tables, is configured by allotting a unique PNID for each of the plurality of tables of the Internal DEV Association Table of the first device.

10. The system as claimed in claim 8, wherein the Internal DEV Association Table is configured by entering a unique PNID into each row of the Internal DEV Association Table of the first device.

11. A method for communicating a first device with a second device coexisting in a piconet system having a parent piconet and at least one child piconet, comprising:
receiving, by a first child piconet coordinator (PNC), information on first member devices from the parent PNC and other child PNCs through first predetermined command frames and storing the information in at least one device information table of the first child PNC;
receiving, by member devices of the first child piconet, information on the first member devices from the first child PNC through second predetermined command frames as received information and storing the received information in respective device information tables of the member devices of the first child piconet;
attempting, by the first device of the first member devices, to communicate with the second device belonging to member devices of a different piconet;
generating, by the first device, a data frame to be transmitted to the second device by use of a device information table of the first device, as generated data; and
transmitting, by the first device, the generated data frame to the second device,
wherein the device information table of the first device comprises an identifier to identify the different piconet.

12. The method as claimed in claim 11, wherein the identifier to identify the different piconet is a piconet identifier (PNID) of the second device as stipulated in IEEE 802.15.3 Standard.

13. The method as claimed in claim 11, wherein the first and the second predetermined command frames are PNC information command frames as stipulated in IEEE 802.15.3 Standard.

14. The method as claimed in claim 11, wherein the device information tables of the first and the second devices comprise Internal DEV Association Tables.

15. The method as claimed in claim 12, wherein the operation of transmitting comprises:
determining, by the first device, whether the PNID of the second device is identical to a PNID of the first device;
directly transmitting, by the first device, data by using a device identifier (DEVID) of the second device when it is determined that the PNIDs of the first and second devices are identical; and
transmitting, by the first device, the data to a PNC of a piconet of the first device, when it is determined that the PNIDs of the first and second devices are different, the PNC of the first device transmitting the data to the PNC of the of the second piconet, and thereafter, the PNC of the second piconet having received the data, transmitting the data to the second device.

16. The method as claimed in claim 14, wherein the Internal DEV Association Table forms a number of tables, wherein the number is equivalent to the number of the parent and the at least one child piconets and allots a unique PNID for the parent and the at least one child piconet in each of the number of tables.

17. The method as claimed in claim 14, wherein the Internal DEV Association Table forms a single table regardless of a number of the parent and the at least one child piconets, and inserts unique PNID for the parent and the at least one child piconet in each column.
